(19) United States
(12) Patent Application Publication
(10) Pub. No.: US 2018/0017715 A1
(43) Pub. Date: Jan. 18, 2018

(54) TRANSPARENT CONDUCTIVE FILM

(71) Applicant: NITTO DENKO CORPORATION, Ibaraki-shi, Osaka (JP)

(72) Inventors: Shoichi Matsuda, Ibaraki-shi (JP); Yuki Hasegawa, Ibaraki-shi (JP); Hiroshi Tomohisa, Ibaraki-shi (JP); Kazumasa Okada, Ibaraki-shi (JP); Hiroyuki Takemoto, Ibaraki-shi (JP)

(73) Assignee: NITTO DENKO CORPORATION, Ibaraki-shi, Osaka (JP)

(21) Appl. No.: 15/546,928

(22) PCT Filed: Jan. 25, 2016
(86) PCT No.: PCT/JP2016/051951

§ 371 Date: Jul. 27, 2017

(30) Foreign Application Priority Data
Jan. 27, 2015 (JP) 2015-013652
Mar. 16, 2015 (JP) 2015-052126
Sep. 11, 2015 (JP) 2015-179340
Sep. 11, 2015 (JP) 2015-179341

(51) Int. Cl. B32B 7/02; H01B 5/14; G02B 5/30

(52) U.S. Cl. CPC G02B 1/16; B32B 7/02; H01B 5/14; G02B 1/14; B32B 2307/202; B32B 2307/42; G02B 5/3033; B32B 2307/412

(57) ABSTRACT

Provided is a transparent conductive film excellent in both scratch resistance and conductivity. The transparent conductive film of the present invention includes: a transparent substrate; and a transparent conductive layer arranged on one side or both sides of the transparent substrate, in which: the transparent conductive layer contains a binder resin, metal nanowires, and metallic particles; and part of the metallic particles protrude from a region formed of the binder resin. In one embodiment, an average particle diameter X of the metallic particles and a thickness Y of the region formed of the binder resin satisfy a relationship of Y≦X≦20Y.

### TECHNICAL FIELD

The present invention relates to a transparent conductive film.

### BACKGROUND ART

A transparent conductive film has heretofore been used in, for example, an electrode for an electronic device part, such as a touch panel, or an electromagnetic wave shield for blocking an electromagnetic wave responsible for the malfunction of an electronic device. Regarding the transparent conductive film, there have been proposed methods of forming a conductive layer formed of a metal oxide layer of ITO or like, metal nanowires, a metal mesh, or the like (for example, Patent Literatures 1 and 2). In such conductive layer, particularly, in a conductive layer containing metal nanowires, a protective layer is formed in order to protect a material for forming the conductive layer.

In order to obtain electrical conduction from the surface of the protective layer, it is necessary to set the thickness of the protective layer to be small. However, when the thickness of the protective layer is set to be small, there is a problem in that the scratch resistance of the transparent conductive film decreases and the reliability is impaired. Meanwhile, when the thickness of the protective layer is set to be large, there arises a problem in that the contact resistance with respect to wiring for electrical connection and a metal paste increases and electrical conduction cannot be obtained therefrom. Thus, it is difficult to realize a transparent conductive film (in particular, a transparent conductive film containing metal nanowires) excellent in both scratch resistance and conductivity.

### CITATION LIST

### Patent Literature

[PTL 1] JP 2009-505358 A

[PTL 2] JP 2014-112510 A

### SUMMARY OF INVENTION

### Technical Problem

The present invention has been made to solve the above-mentioned problems, and an object of the present invention is to provide a transparent conductive film excellent in both scratch resistance and conductivity.

### Solution to Problem

According to one aspect of the present invention, there is provided a transparent conductive film, including: a transparent substrate; and a transparent conductive layer arranged on one side or both sides of the transparent substrate, in which: the transparent conductive layer contains a binder resin, metal nanowires, and metallic particles; and part of the metallic particles protrude from a region formed of the binder resin.

In one embodiment, an average particle diameter X of the metallic particles and a thickness Y of the region formed of the binder resin satisfy a relationship of Y≦X≦20Y.

In one embodiment, the metallic particles have an average primary particle diameter of from 5 nm to 100 μm.

In one embodiment, a content ratio of the metallic particles is from 0.1 part by weight to 20 parts by weight with respect to 100 parts by weight of the binder resin.

In one embodiment, the metallic particles have an average ellipticity of 40% or less.

In one embodiment, the metallic particles include silver particles.

In one embodiment, the metallic particles include silver-coated copper particles.

According to another aspect of the present invention, there is provided an optical laminate. The optical laminate includes the above-mentioned transparent conductive film and a polarizing plate.

### Advantageous Effects of Invention

According to the present invention, by virtue of the presence of the metallic particles protruding from the transparent conductive layer, the transparent conductive film excellent in both scratch resistance and conductivity can be provided.

### BRIEF DESCRIPTION OF DRAWINGS

FIG. 1 is a schematic sectional view of a transparent conductive film according to one embodiment of the present invention.

### DESCRIPTION OF EMBODIMENTS

A. Entire Configuration of Transparent Conductive Film

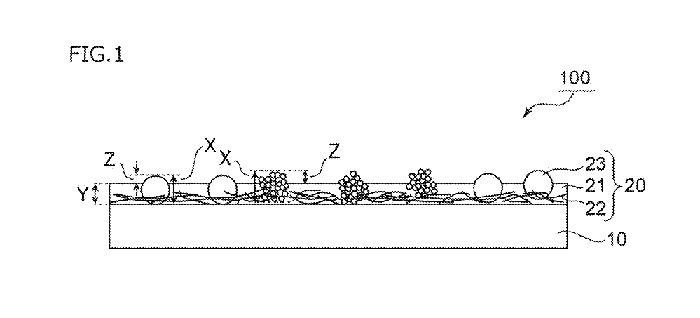

FIG. 1 is a schematic sectional view of a transparent conductive film according to one embodiment of the present invention. A transparent conductive film 100 includes a transparent substrate 10 and a transparent conductive layer 20 arranged on one side or both sides (in the illustrated example, one side) of the transparent substrate 10. The transparent conductive layer 20 includes a binder resin 21, metal nanowires 22, and metallic particles 23.

Part of the metallic particles 23 protrude from a region formed of the binder resin 21 toward the surface of the transparent conductive film. That is, in the transparent conductive film, the metallic particles are exposed. With such configuration, electrical conduction can be obtained satisfactorily on the surface of the transparent conductive film. Further, the contact resistance can be decreased. In addition, the binder resin may protect the metal nanowires, and in the invention of the present application, by virtue of the presence of the metallic particles that are exposed, the usage amount of the binder resin can be increased (that is, the region formed of the binder resin can be made thick). As a result, a transparent conductive film excellent in scratch resistance can be obtained. It is one of the achievements of the present invention that the transparent conductive film can be realized, which enables electrical conduction from the surface to be ensured due to excellent conductivity and has low contact resistance, while the region of the binder resin serving as the protective layer is made thick to increase scratch resistance.

The surface resistance value of the transparent conductive film of the present invention is preferably from 0.1Ω/□ to 1,000Ω/□, more preferably from 0.5Ω/□ to 300Ω/□, particularly preferably from 1Ω/□ to 200Ω/□.

The haze value of the transparent conductive film of the present invention is preferably 20% or less, more preferably 10% or less, still more preferably from 0.1% to 5%.

The total light transmittance of the transparent conductive film of the present invention is preferably 30% or more, more preferably 35% or more, still more preferably 40% or more, particularly preferably 89% or more, most preferably 90% or more. It is preferred that the total light transmittance of the transparent conductive film be as high as possible, but the upper limit thereof is, for example, 98%.

B. Transparent Conductive Layer

As described above, the transparent conductive layer includes the binder resin, the metal nanowires, and the metallic particles. The binder resin is present so as to cover the metal nanowires and at least part of the metallic particles, and the region formed of the binder resin may serve as the protective layer. Part of the metallic particles protrude from the region formed of the binder resin.

The total light transmittance of the transparent conductive layer is preferably 85% or more, more preferably 90% or more, still more preferably 95% or more.

B-1. Binder Resin

A thickness Y of the region formed of the binder resin is preferably from 0.15 μm to 5 μm, more preferably from 0.15 μm to 3 μm, still more preferably from 0.15 μm to 2 μm. In this description, as illustrated in FIG. 1, the thickness Y of the region formed of the binder resin refers to a distance from one flat surface of the transparent conductive layer to the other flat surface thereof, in other words, the thickness of the transparent conductive layer when it is assumed that the protruding portions of the metallic particles are excluded. In the present invention, electrical conduction can be ensured with the metallic particles, and hence the region formed of the binder resin can be made relatively thick. As a result, a transparent conductive film excellent in scratch resistance can be obtained.

As the binder resin, any appropriate resin may be used. Examples of the resin include: an acrylic resin; a polyester-based resin, such as polyethylene terephthalate; an aromatic resin, such as polystyrene, polyvinyltoluene, polyvinylxylene, polyimide, polyamide, or polyamide imide; a polyurethane-based resin; an epoxy-based resin; a polyolefin-based resin; an acrylonitrile-butadiene-styrene copolymer (ABS); cellulose; a silicon-based resin; polyvinyl chloride; polyacetate; polynorbornene; a synthetic rubber; and a fluorine-based resin.

In one embodiment, as the binder resin, a curable resin is used. The curable resin may be obtained from a monomer composition containing a polyfunctional monomer. Examples of the polyfunctional monomer include tricyclodecanedimethanol diacrylate, pentaerythritol di(meth)acrylate, pentaerythritol tri(meth)acrylate, trimethylolpropane triacrylate, pentaerythritol tetra(meth)acrylate, dimethylolpropane tetraacrylate, dipentaerythritol hexa(meth)acrylate, 1,6-hexanediol (meth)acrylate, 1,9-nonanediol diacrylate, 1,10-decanediol (meth)acrylate, polyethylene glycol di(meth)acrylate, polypropylene glycol di(meth)acrylate, dipropylene glycol diacrylate, isocyanuric acid tri(meth)acrylate, ethoxylated glycerin triacrylate, and ethoxylated pentaerythritol tetraacrylate. The polyfunctional monomers may be used alone or in combination thereof.

The monomer composition may further contain a monofunctional monomer. When the monomer composition contains the monofunctional monomer, the content ratio of the monofunctional monomer is preferably 40 parts by weight or less, more preferably 20 parts by weight or less with respect to 100 parts by weight of the monomers in the monomer composition.

Examples of the monofunctional monomer include ethoxylated o-phenylphenol (meth)acrylate, methoxy polyethylene glycol (meth)acrylate, phenoxy polyethylene glycol (meth)acrylate, 2-ethylhexyl acrylate, lauryl acrylate, isooctyl acrylate, isostearyl acrylate, cyclohexyl acrylate, isobornyl acrylate, benzyl acrylate, 2-hydroxy-3-phenoxy acrylate, acryloylmorpholine, 2-hydroxyethyl (meth)acrylate, 4-hydroxybutyl (meth)acrylate, and hydroxyethylacrylamide. In one embodiment, a monomer having a hydroxyl group is used as the monofunctional monomer.

B-2. Metal Nanowire

The metal nanowire refers to a conductive substance that uses a metal as a material, has a needle- or thread-like shape, and has a diameter of the order of nanometers. The metal nanowire may be linear or may be curved. When a transparent conductive layer formed of the metal nanowires is used, the metal nanowires are formed into a network shape. Accordingly, even when the metal nanowires are used in a small amount, a good electrical conduction path can be formed, and hence a transparent conductive film having a small electrical resistance can be obtained. In addition, the metal nanowires are formed into a network shape, and hence an opening portion is formed in a gap of the network. As a result, a transparent conductive film having a high light transmittance can be obtained.

A ratio (aspect ratio: L/d) between a thickness d and length L of the metal nanowires is preferably from 10 to 100,000, more preferably from 50 to 100,000, particularly preferably from 100 to 10,000. When metal nanowires having such large aspect ratio as described above are used, the metal nanowires satisfactorily intersect with each other, and hence high conductivity can be expressed with a small amount of the metal nanowires. As a result, a transparent conductive film having a high light transmittance can be obtained. The term “thickness of the metal nanowires” as used herein has the following meanings: when each section of the metal nanowires has a circular shape, the term means the diameter of the circle; when the section has an elliptical shape, the term means the short diameter of the ellipse; and when the section has a polygonal shape, the term means the longest diagonal of the polygon. The thickness and length of the metal nanowires may be observed with a scanning electron microscope or a transmission electron microscope.

The thickness of the metal nanowires is preferably less than 500 nm, more preferably less than 200 nm, particularly preferably from 10 nm to 100 nm, most preferably from 10 nm to 50 nm. When the thickness falls within such range, a transparent conductive layer having a high light transmittance can be formed.

The length of the metal nanowires is preferably from 1 μm to 1,000 μm, more preferably from 10 μm to 500 μm, particularly preferably from 10 μm to 100 μm. When the length falls within such range, a transparent conductive film having high conductivity can be obtained.

Any appropriate metal may be used as a metal forming the metal nanowires as long as the metal is conductive. Examples of the metal forming the metal nanowires include silver, gold, copper, and nickel. In addition, a material obtained by subjecting any such metal to plating treatment (e.g., gold plating treatment) may be used. Of those, silver, copper, or gold is preferred from the viewpoint of conductivity, and silver is more preferred.

Any appropriate method may be adopted as a method of producing the metal nanowires. Examples thereof include: a method involving reducing silver nitrate in a solution; and a method involving causing an applied voltage or current to act on a precursor surface from the tip portion of a probe, drawing metal nanowires at the tip portion of the probe, and continuously forming the metal nanowires. In the method involving reducing silver nitrate in the solution, silver nanowires may be synthesized by performing the liquid-phase reduction of a silver salt, such as silver nitrate, in the presence of a polyol, such as ethylene glycol, and polyvinyl pyrrolidone. The mass production of silver nanowires having a uniform size may be performed in conformity with a method disclosed in, for example, Xia, Y. et al., Chem. Mater. (2002), 14, 4736-4745 or Xia, Y. et al., Nano letters (2003), 3(7), 955-960.

The content ratio of the metal nanowires in the transparent conductive layer is preferably from 0.1 part by weight to 50 parts by weight, more preferably from 0.1 part by weight to 30 parts by weight with respect to 100 parts by weight of the binder resin forming the transparent conductive layer. When the content ratio falls within such range, a transparent conductive film excellent in conductivity and light transmittance can be obtained.

B-3. Metallic Particle

The metallic particles in the transparent conductive layer may be present as single particles or as an aggregate. Further, the single particles and the aggregate may be mixed.

An average particle diameter X of the metallic particles and the thickness Y of the region formed of the binder resin satisfy a relationship of preferably Y≦X≦20Y, more preferably Y≦X≦15Y, still more preferably Y≦X≦10Y. The reason for this is as follows. When Y≦X is satisfied, part of the metallic particles can protrude from the region formed of the binder resin to contribute to electrical conduction, and higher conductivity can be ensured. Meanwhile, when X≦20Y is satisfied, the metallic particles are held satisfactorily in the transparent conductive layer. Further, when X≦10Y is satisfied, the metallic particles are held more satisfactorily, and a transparent conductive film having significantly low resistance can be obtained. When the simple term “average particle diameter” is used in this description, the term “average particle diameter” refers to a concept including both an average particle diameter (primary particle diameter) of the metallic particles that are present as single particles and an average particle diameter (secondary particle diameter) of an aggregate of the metallic particles that are present as the aggregate. The average particle diameter and an average primary particle diameter (described later) of the metallic particles forming the aggregate are each a median diameter (50% diameter; on a number basis) of a particle diameter (long axis diameter) measured by observing 100 particles sampled randomly from an image of a surface or a section of a transparent conductive layer with a microscope (for example, an optical microscope, a scanning electron microscope, or a transmission electron microscope).

The average primary particle diameter of the metallic particles present in the transparent conductive layer is preferably from 5 nm to 100 μm, more preferably from 10 nm to 50 μm, still more preferably from 20 nm to 10 μm. When the average primary particle diameter falls within such range, a transparent conductive layer excellent in electrical conduction can be formed. Further, a transparent conductive film that is more excellent in scratch resistance can be obtained by setting the average primary particle diameter of the metallic particles to 10 μm or less.

In one embodiment, an aspect ratio (ratio L/d between thickness (short axis diameter) d and length (long axis diameter) L) of the metallic particles is preferably 2.0 or less, more preferably 1.5 or less. When the aspect ratio falls within such range, the protruding portion (portion protruding from the region formed of the binder resin) of the metallic particles can be formed easily.

In another embodiment, the average ellipticity of the metallic particles is preferably 40% or less, more preferably 30% or less, still more preferably 20% or less, particularly preferably 10% or less. The lower limit of the average ellipticity of the metallic particles is, for example, 1%. In this description, the “average ellipticity” is calculated based on the ellipticity of the metallic particles present as single particles and the ellipticity of an aggregate of the metallic particles present as the aggregate. More specifically, the average ellipticity is calculated by the expression “Average ellipticity (%)=(1−D2/D1)×100” based on a median diameter (50% diameter; on a number basis) D1 of a long diameter of 30 particles (metallic particles present as single particles, and an aggregate) sampled randomly from an image of a section of a transparent conductive layer with a microscope (for example, an optical microscope, a scanning electron microscope, or a transmission electron microscope) and a median diameter (50% diameter; on a number basis) D2 of a short diameter thereof. The definition of the “average ellipticity” means that it is not necessary that all of the metallic particles (or an aggregate of the metallic particles) fall within the above-mentioned range. The number of the metallic particles having an ellipticity of 40% or less is preferably 80 or more, more preferably 90 or more with respect to 100 metallic particles.

In the present invention, a decrease in light transmittance caused by the metallic particles can be suppressed through use of the metallic particles having the above-mentioned average ellipticity. Meanwhile, it is considered that, when the metallic particles having a high ellipticity are used, the high ellipticity particles are aligned so as to fall (that is, so that a surface including the long diameter becomes substantially parallel to front and back surfaces of the transparent conductive film), and as a result, back scattering becomes strong. In the above-mentioned embodiment, it is considered that such back scattering is suppressed, and a decrease in light transmittance is suppressed as described above.

The metallic particles having the above-mentioned ellipticity can be obtained by any appropriate method as long as the effect of the present invention is obtained. For example, the metallic particles can be obtained by the wet reduction method. As a method of obtaining silver particles by the wet reduction method, there is given, for example, a method involving adding an alkali or a complexing agent to an aqueous solution containing a silver salt to generate a slurry containing silver oxide or an aqueous solution containing a silver complex salt, and adding a reducing agent to the resultant to precipitate silver particles through reduction. The detail of the wet reduction method is disclosed in, for example, JP 07-76710 A, JP 2013-189704 A, and JP 08-176620 A, and the disclosures of those patent literatures are incorporated herein by reference. Further, the aggregate having the above-mentioned average ellipticity can be formed by, for example, any appropriate method (for example, the wet reduction method) through use of single particles having a low ellipticity (for example, an average ellipticity of 40% or less).

The content ratio of the metallic particles is preferably from 0.1 part by weight to 20 parts by weight, more preferably from 0.2 part by weight to 10 parts by weight with respect to 100 parts by weight of the binder resin. When the content ratio falls within such range, a transparent conductive film excellent in both electrical conduction and scratch resistance can be obtained. Further, a transparent conductive film excellent in transparency can be obtained.

The content ratio of the metallic particles is preferably from 1 part by weight to 100 parts by weight, more preferably from 10 parts by weight to 70 parts by weight with respect to 100 parts by weight of the metal nanowires. When the content ratio falls within such range, a transparent conductive film excellent in conductivity and transparency can be obtained.

The metallic particles contain a conductive metal. In one embodiment, metallic particles having a single layer configuration are used. In another embodiment, metallic particles, in which each surface of any appropriate core particles is subjected to coating treatment (for example, plating treatment) with the conductive metal, are used. As a material for forming the core particles, there are given, for example, the above-mentioned conductive metal, insulator particles containing an organic substance or an inorganic substance, and semiconductor particles. As the conductive metal, any appropriate metal may be used. As a specific example of the conductive metal, there are given, for example, silver, gold, copper, nickel, and palladium. As the conductive metal, metallic particles using silver, copper, or gold are preferably used, and metallic particles using silver are more preferably used. Further, as an example of the metallic particles obtained by the coating treatment, there are given silver-coated copper particles. When particles formed of a metal oxide are used, there is a risk in that sufficient electrical conduction may not be obtained.

B-4. Method of Forming Transparent Conductive Layer

The transparent conductive layer may be formed by, for example, applying a composition for forming a transparent conductive layer onto the transparent substrate. In one embodiment, the composition for forming a transparent conductive layer contains a binder resin, metal nanowires, and metallic particles.

In another embodiment, a transparent conductive layer may be formed by applying (coating, drying) a composition (NP) for forming a transparent conductive layer containing metal nanowires and metallic particles, and then applying a composition (R) for forming a transparent conductive layer containing a binder resin. In this case, the composition (NP) for forming a transparent conductive layer containing metal nanowires and metallic particles may contain a binder resin, any appropriate resin capable of enhancing dispersion stability, or the like.

In yet another embodiment, a transparent conductive layer may be formed by applying (coating, drying) a composition (N) for forming a transparent conductive layer containing metal nanowires, and then applying a composition (RP) for forming a transparent conductive layer containing a binder resin and metallic particles. In this case, the composition (N) for forming a transparent conductive layer containing metal nanowires may contain a binder resin, any appropriate resin capable of enhancing dispersion stability, or the like.

In yet another embodiment, a transparent conductive layer may be formed by applying (coating, drying) a composition (P) for forming a transparent conductive layer containing metallic particles, and then applying a composition (RN) for forming a transparent conductive layer containing a binder resin and metal nanowires. In this case, the composition (P) for forming a transparent conductive layer containing metallic particles may contain a binder resin, any appropriate resin capable of enhancing dispersion stability, or the like.

The composition (NP, N, RP, P, RN) for forming a transparent conductive layer containing metallic particles and/or metal nanowires is preferably a dispersion liquid obtained by dispersing metal nanowires and/or metallic particles in any appropriate solvent. Examples of the solvent include water, an alcohol-based solvent, a ketone-based solvent, an ether-based solvent, a hydrocarbon-based solvent, and an aromatic solvent.

The dispersion concentration of the metal nanowires in the composition (NP, N, RN) for forming a transparent conductive layer containing the metal nanowires is preferably from 0.01 wt % to 5 wt %. When the dispersion concentration falls within such range, a transparent conductive layer excellent in conductivity and light transmittance can be formed.

The dispersion concentration of the metallic particles in the composition (NP, RP, P) for forming a transparent conductive layer containing the metallic particles is preferably from 0.001 wt % to 5 wt %. When the dispersion concentration falls within such range, a transparent conductive layer excellent in conductivity and light transmittance can be formed.

The composition (NP, N, RP, P, RN) for forming a transparent conductive layer containing the metallic particles and/or the metal nanowires may further contain any appropriate additive depending on purposes. Examples of the additive include an anticorrosive material for preventing the corrosion of the metal nanowires and/or the metallic particles, and a surfactant for preventing the agglomeration of the metal nanowires. Further, the composition for forming a transparent conductive layer may contain an additive, such as a plasticizer, a heat stabilizer, a light stabilizer, a lubricant, an antioxidant, a UV absorber, a flame retardant, a colorant, an antistatic agent, a compatibilizer, a crosslinking agent, a thickener, inorganic particles, a surfactant, or a dispersant. Further, the composition (R) for forming a transparent conductive layer containing a binder resin may contain any appropriate solvent. The kinds, number, and amount of additives to be used may be set appropriately depending on purposes.

Any appropriate method may be adopted as an application method for the composition for forming a transparent conductive layer. Examples of the application method include spray coating, bar coating, roll coating, die coating, inkjet coating, screen coating, dip coating, a relief printing method, an intaglio printing method, and a gravure printing method. Any appropriate drying method (e.g., natural drying, blast drying, or heat drying) may be adopted as a method of drying the applied layer. In the case of, for example, the heat drying, a drying temperature is typically from 80° C. to 150° C. and a drying time is typically from 1 minute to 20 minutes. Further, after the composition (R, RP, RN) for forming a transparent conductive layer containing a binder resin is applied, the applied layer may be subjected to curing treatment (for example, heating treatment and UV light irradiation treatment).

C. Transparent Substrate

As a material for forming the transparent substrate, any appropriate material may be used. Specifically, for example, a film or a polymer substrate is preferably used. This is because the smoothness of the transparent substrate and the wettability with respect to the composition for forming a transparent conductive layer are excellent, and the productivity by continuous production with a roll may be significantly enhanced.

The material for forming the transparent substrate is typically a polymer film containing a thermoplastic resin as a main component. Examples of the thermoplastic resin include: a polyester-based resin; a cycloolefin-based resin, such as polynorbornene; an acrylic resin; a polycarbonate resin; and a cellulose-based resin. Of those, a polyester-based resin, a cycloolefin-based resin, or an acrylic resin is preferred. Those resins are excellent in, for example, transparency, mechanical strength, thermal stability, and moisture barrier property. The thermoplastic resins may be used alone or in combination thereof. Further, an optical film as used in a polarizing plate, for example, a low-retardation substrate, a high-retardation substrate, a retardation plate, or a brightness enhancement film may also be used as a substrate.

The thickness of the transparent substrate is preferably from 20 μm to 200 μm, more preferably from 30 μm to 150 μm.

The total light transmittance of the transparent substrate is preferably 30% or more, more preferably 35% or more, still more preferably 40% or more.

D. Optical Laminate

The transparent conductive film may be used in a touch sensor. In a touch sensor including the transparent conductive film, the transparent conductive film may serve as, for example, an electrode or an electromagnetic shield. In one embodiment, there is provided an optical laminate obtained by laminating the transparent conductive film and a polarizing plate. The transparent conductive film and the polarizing plate may be bonded to each other through intermediation of any appropriate adhesive or pressure-sensitive adhesive. As the polarizing plate, any appropriate polarizing plate may be used. The optical laminate may be suitably used as a polarization element having touch sensor characteristics or electromagnetic shield characteristics. The optical laminate is used as, for example, a viewer-side polarizing plate or a back surface-side polarizing plate of a liquid crystal cell of a liquid crystal display apparatus.

### EXAMPLES

Now, the present invention is specifically described by way of Examples. However, the present invention is by no means limited to these Examples.

### Examples A1 to A11 and Comparative Examples A1 and A2

Evaluation methods in Examples A1 to A11 and Comparative Examples A1 and A2 are as described below. The thickness was measured as follows: a transparent conductive film was subjected to embedding treatment with an epoxy resin, and then a section was formed by cutting the resultant with an ultramicrotome, followed by the measurement of the thickness of the section with a scanning electron microscope “S-4800” manufactured by Hitachi High-Technologies Corporation.

### (1) Haze Value

A sample was bonded to glass with a pressure-sensitive adhesive, and measurement was performed with a product available under the product name “HR-100” from Murakami Color Research Laboratory Co., Ltd. at 23° C.

### (2) Surface Resistance Value

The surface resistance value of a transparent conductive film was measured with a noncontact surface resistance meter available under the product name “EC-80” from Napson Corporation by an eddy current method. The measurement was performed at a temperature of 23° C.

### (3) Contact Resistance Value

Lines (20 mm (length)×1 mm (width)) of a silver paste were applied onto a transparent conductive layer at predetermined intervals (5 mm, 15 mm, and 35 mm), and a resistance value between two points was measured with a product available under the product name “Digital Multimeter CD800a” from Sanwa Electric Instrument Co., Ltd. A linear equation was obtained based on the correlation between the distance of two points and the resistance value, and an intercept was divided by 2 to provide a contact resistance value of the transparent conductive film.

### (4) Scratch Resistance

The scratch resistance of a transparent conductive layer of a transparent conductive film was evaluated under the condition that steel wool #0000 was used, and a probe having a radius of 25 mm was reciprocated ten times with a length of 10 cm under a load of 300 g. The case where ten or less scratches were visually confirmed in a center portion (25 mm×25 mm) was defined as o, and the case where more than ten scratches were visually confirmed was defined as x.

### (5) Measurement of Size of Metal Nanowire and Metallic Particle

Measurement was performed through use of an optical microscope “BX-51” manufactured by Olympus Corporation, a scanning electron microscope “S-4800” manufactured by Hitachi High-Technologies Corporation, and a field-emission transmission electron microscope “HF-2000” manufactured by Hitachi High-Technologies Corporation. An average particle diameter was defined as a median diameter (50% diameter; on a number basis) of particle diameters measured by observing 100 particles sampled randomly from a surface or a section of a transparent conductive layer with the microscope.

### (6) Height of Protruding Portion

Measurement was performed in conformity with JIS B 0031:2001 through use of a nanoscale hybrid microscope (product name: VN-8000) manufactured by Keyence Corporation. A ten-point average roughness Rz in a 200 μm square measurement area was defined as a height of a protruding portion.

### Production Example A1

### (Production of Metal Nanowire)

5 ml of anhydrous ethylene glycol and 0.5 ml of a solution of PtCl₂ in anhydrous ethylene glycol (concentration: 1.5×10⁻⁴ mol/L) were added to a reaction vessel with a stirrer under 160° C. After a lapse of 4 minutes, 2.5 ml of a solution of AgNO₃ in anhydrous ethylene glycol (concentration: 0.12 mol/l) and 5 ml of a solution of polyvinyl pyrrolidone (MW: 55,000) in anhydrous ethylene glycol (concentration: 0.36 mol/l) were simultaneously dropped to the resultant solution over 6 minutes. After the dropping, the mixture was heated to 160° C. and a reaction was performed for 1 hour or more until AgNO₃ was completely reduced, to produce silver nanowires. Next, acetone was added to the reaction mixture containing the silver nanowires obtained as described above until the volume of the reaction mixture became 5 times as large as that before the addition. After that, the reaction mixture was centrifuged (2,000 rpm, 20 minutes). Thus, silver nanowires were obtained.

The resultant silver nanowires each had a short diameter of from 30 nm to 40 nm, a long diameter of from 30 nm to 50 nm, and a length of from 5 μm to 50 μm.

The silver nanowires (concentration: 0.2 wt %) and pentaethylene glycol dodecyl ether (concentration: 0.1 wt %) were dispersed in pure water to prepare a silver nanowire dispersion liquid a.

### Example A1

### (Preparation of First Composition (PN) for Forming Transparent Conductive Layer)

25 parts by weight of the silver nanowire dispersion liquid a and 2 parts by weight of a water dispersion liquid of 1 wt % silver particles (average primary particle diameter: 1.3 μm) were diluted with 73 parts by weight of pure water to prepare a first composition (PN) for forming a transparent conductive layer having a solid content concentration of 0.07 wt %.

### (Preparation of Second Composition (R) for Forming Transparent Conductive Layer)

3.6 parts by weight of pentaerythritol triacrylate (manufactured by Osaka Organic Chemical Industry Ltd., product name: “Viscoat#300”), 2.7 parts by weight of organosilicasol (manufactured by Nissan Chemical Industries. Ltd., product name: “MEK-AC-2140Z”, concentration: 40%), and 0.2 part by weight of a photopolymerization initiator (manufactured by BASF, product name: “IRGACURE 907”) were diluted with 93 parts by weight of cyclopentanone to provide a second composition (R) for forming a transparent conductive layer having a solid content concentration of 5 wt %.

### (Production of Transparent Conductive Film)

The first composition (PN) for forming a transparent conductive layer was applied onto a PET substrate (manufactured by Mitsubishi Plastics, Inc., product name: “T602”, thickness: 50 μm) through use of a wire bar No. 26 (manufactured by Mitsui Electric Co., Ltd.) and was dried.

In addition, the second composition (R) for forming a transparent conductive layer was applied onto the dried composition by spin coating (1,000 rpm, 5 seconds), and was dried at 90° C. for 1 minute. After that, the resultant was irradiated with UV light at 300 mJ/cm² to provide a transparent conductive film (content ratio of metallic particles with respect to 100 parts by weight of a binder resin: 2.5 parts by weight). In this transparent conductive film, a thickness Y of a region formed of the binder resin (for convenience, shown as “Thickness of transparent conductive layer” in Table 1) was 0.3 μm, and a height Z of a protruding portion of the metallic particle was 0.9 μm. Further, the transparent conductive film had a surface resistance value of 50.3 Ω/□, a contact resistance value of 1.2Ω, and a haze value of 2.9%, and the scratch resistance thereof was evaluated as o.

### Example A2

A transparent conductive film (content ratio of metallic particles with respect to 100 parts by weight of a binder resin: 0.7 part by weight), in which a thickness Y of a region formed of the binder resin was 1 μm and a height Z of a protruding portion of the metallic particle was 0.4 μm, was obtained in the same manner as in Example A1 except that the spin coating condition at the time of application of the second composition (R) for forming a transparent conductive layer was set to 400 rpm and 5 seconds. The transparent conductive film had a surface resistance value of 51.2Ω/□, a contact resistance value of 3.7Ω, and a haze value of 3.0%, and the scratch resistance thereof was evaluated as o.

### Example A3

A transparent conductive film (content ratio of metallic particles with respect to 100 parts by weight of a binder resin: 2.4 parts by weight) was obtained in the same manner as in Example A1 except that a water dispersion liquid of 1 wt % silver particles (average primary particle diameter: 20 nm) was used instead of the water dispersion liquid of 1 wt % silver particles (average primary particle diameter: 1.3 μm). In this transparent conductive film, a thickness Y of a region formed of the binder resin was 0.3 μm, and a height Z of a protruding portion of the metallic particle was 1.3 μm. Further, the transparent conductive film had a surface resistance value of 49.8Ω/□, a contact resistance value of 0.4Ω, and a haze value of 2.5%, and the scratch resistance thereof was evaluated as o. When the section of this film was checked with a transmission electron microscope, a silver aggregate having an average particle diameter (long axis diameter) of 1.5 μm was observed.

### Example A4

A transparent conductive film (content ratio of metallic particles with respect to 100 parts by weight of a binder resin: 2.5 parts by weight) was obtained in the same manner as in Example A1 except that a water dispersion liquid of 1 wt % silver particles (average primary particle diameter: 1.7 μm) was used instead of the water dispersion liquid of 1 wt % silver particles (average primary particle diameter: 1.3 μm). In this transparent conductive film, a thickness Y of a region formed of the binder resin was 0.3 μm, and a height Z of a protruding portion of the metallic particle was 1.5 μm. Further, the transparent conductive film had a surface resistance value of 49.1Ω/□, a contact resistance value of 2.8Ω, and a haze value of 2.0%, and the scratch resistance thereof was evaluated as o.

### Example A5

A transparent conductive film (content ratio of metallic particles with respect to 100 parts by weight of a binder resin: 2.5 parts by weight) was obtained in the same manner as in Example A1 except that a water dispersion liquid of 1 wt % silver particles (average primary particle diameter: 5.1 μm) was used instead of the water dispersion liquid of 1 wt % silver particles (average primary particle diameter: 1.3 μm). In this transparent conductive film, a thickness Y of a region formed of the binder resin was 0.3 μm, and a height Z of a protruding portion of the metallic particle was 4.8 μm. Further, the transparent conductive film had a surface resistance value of 53.0Ω/□, a contact resistance value of 11.3Ω, and a haze value of 1.8%, and the scratch resistance thereof was evaluated as o.

### Example A6

A transparent conductive film (content ratio of metallic particles with respect to 100 parts by weight of a binder resin: 2.5 parts by weight) was obtained in the same manner as in Example A1 except that a water dispersion liquid of 1 wt % silver-coated copper particles (average primary particle diameter: 1.1 μm, silver coat content: 10%) was used instead of the water dispersion liquid of 1 wt % silver particles (average primary particle diameter: 1.3 μm). In this transparent conductive film, a thickness Y of a region formed of the binder resin was 0.3 μm, and a height Z of a protruding portion of the metallic particle was 0.7 μm. Further, the transparent conductive film had a surface resistance value of 52.1Ω/□, a contact resistance value of 3.0Ω, and a haze value of 2.5%, and the scratch resistance thereof was evaluated as o.

### Example A7

### (Preparation of First Composition (N) for Forming Transparent Conductive Layer)

25 parts by weight of the silver nanowire dispersion liquid a was diluted with 75 parts by weight of pure water to prepare a first composition (N) for forming a transparent conductive layer having a solid content concentration of 0.05 wt %.

### (Preparation of Second Composition (RP) for Forming Transparent Conductive Layer)

3.6 parts by weight of pentaerythritol triacrylate (manufactured by Osaka Organic Chemical Industry Ltd., product name: “Viscoat#300”), 2.7 parts by weight of organosilicasol (manufactured by Nissan Chemical Industries. Ltd., product name: “MEK-AC-2140Z”, concentration: 40%), 0.2 part by weight of a photopolymerization initiator (manufactured by BASF, product name: “IRGACURE 907”), and 15 parts by weight of a cyclopentanone dispersion liquid of 1 wt % silver particles (average primary particle diameter: 1.3 μm) were diluted with 78.5 parts by weight of cyclopentanone to provide a second composition (N) for forming a transparent conductive layer having a solid content concentration of 5 wt %.

### (Production of Transparent Conductive Film)

A transparent conductive film (content ratio of metallic particles with respect to 100 parts by weight of a binder resin: 3.1 parts by weight) was obtained in the same manner as in Example A1 except that a first composition (N) for forming a transparent conductive layer and a second composition (RP) for forming a transparent conductive layer were used as the first and second compositions for forming a transparent conductive layer. In this transparent conductive film, a thickness Y of a region formed of the binder resin was 0.3 μm, and a height Z of a protruding portion of the metallic particle was 1.1 μm. Further, the transparent conductive film had a surface resistance value of 53.2Ω/□, a contact resistance value of 1.5Ω, and a haze value of 2.8%, and the scratch resistance thereof was evaluated as o.

### Example A8

A transparent conductive film (content ratio of metallic particles with respect to 100 parts by weight of a binder resin: 3.1 parts by weight) was obtained in the same manner as in Example A7 except that a cyclopentanone dispersion liquid of 1 wt % silver particles (average primary particle diameter: 20 nm) was used instead of the cyclopentanone dispersion liquid of 1 wt % silver particles (average primary particle diameter: 1.3 μm). In this transparent conductive film, a thickness Y of a region formed of the binder resin was 0.3 μm, and a height Z of a protruding portion of the metallic particle was 0.7 μm. Further, the transparent conductive film had a surface resistance value of 50.9 Ω/□, a contact resistance value of 0.8Ω, and a haze value of 2.6%, and the scratch resistance thereof was evaluated as o. When the section of this film was checked with a transmission electron microscope, a silver aggregate having an average particle diameter (long axis diameter) of 1.5 μm was observed.

### Example A9

A transparent conductive film (content ratio of metallic particles with respect to 100 parts by weight of a binder resin: 3.1 parts by weight) was obtained in the same manner as in Example A7 except that a cyclopentanone dispersion liquid of 1 wt % silver particles (average primary particle diameter: 1.7 nm) was used instead of the cyclopentanone dispersion liquid of 1 wt % silver particles (average primary particle diameter: 1.3 μm). In this transparent conductive film, a thickness Y of a region formed of the binder resin was 0.3 μm, and a height Z of a protruding portion of the metallic particle was 1.6 μm. Further, the transparent conductive film had a surface resistance value of 52.3Ω/□, a contact resistance value of 2.4Ω, and a haze value of 3.0%, and the scratch resistance thereof was evaluated as o.

### Example A10

A transparent conductive film (content ratio of metallic particles with respect to 100 parts by weight of a binder resin: 3.1 parts by weight) was obtained in the same manner as in Example A7 except that a cyclopentanone dispersion liquid of 1 wt % silver particles (average primary particle diameter: 5.1 μm) was used instead of the cyclopentanone dispersion liquid of 1 wt % silver particles (average primary particle diameter: 1.3 μm). In this transparent conductive film, a thickness Y of a region formed of the binder resin was 0.3 μm, and a height Z of a protruding portion of the metallic particle was 4.9 μm. Further, the transparent conductive film had a surface resistance value of 54.2Ω/□, a contact resistance value of 8.4Ω, and a haze value of 2.0%, and the scratch resistance thereof was evaluated as o.

### Example A11

A transparent conductive film (content ratio of metallic particles with respect to 100 parts by weight of a binder resin: 3.1 parts by weight) was obtained in the same manner as in Example A7 except that a cyclopentanone dispersion liquid of 1 wt % silver-coated copper particles (average primary particle diameter: 1.1 μm, silver coat content: 10%) was used instead of the cyclopentanone dispersion liquid of 1 wt % silver particles (average primary particle diameter: 1.3 μm). In this transparent conductive film, a thickness Y of a region formed of the binder resin was 0.3 μm, and a height Z of a protruding portion of the metallic particle was 0.9 μm. Further, the transparent conductive film had a surface resistance value of 57.4Ω/□, a contact resistance value of 3.4Ω, and a haze value of 2.1%, and the scratch resistance thereof was evaluated as o.

### Comparative Example A1

The first composition (N) for forming a transparent conductive layer that was prepared in Example A7 was applied onto a PET substrate (manufactured by Mitsubishi Plastics, Inc., product name: “T602”, thickness: 50 μm) through use of a wire bar No. 26 (manufactured by Mitsui Electric Co., Ltd.) and was dried.

In addition, the second composition (R) for forming a transparent conductive layer that was prepared in Example A1 was applied onto the dried composition by spin coating (1,000 rpm, 5 seconds), and was dried at 90° C. for 1 minute. After that, the resultant was irradiated with UV light at 300 mJ/cm to provide a transparent conductive film (that is, a transparent conductive film not containing metallic particles). In this transparent conductive film, a thickness Y of a region formed of the binder resin was 0.3 μm. Further, this transparent conductive film had a surface resistance value of 52.1Ω/□. However, the contact resistance value thereof was more than 300Ω, and hence was not able to be measured. The transparent conductive film had a haze value of 1.6%, and the scratch resistance thereof was evaluated as o.

### Comparative Example A2

A transparent conductive film (content ratio of metallic particles with respect to 100 parts by weight of a binder resin: 2.5 parts by weight) was obtained in the same manner as in Example A1 except that a water dispersion liquid of 1 wt % antimony tin oxide particles prepared through use of antimony tin oxide particles (manufactured by Sigma-Aldrich Co. LLC, average primary particle diameter: 20 nm) serving as semiconductor particles and pure water was used instead of the water dispersion liquid of 1 wt % silver particles (average primary particle diameter: 1.3 μm). In this transparent conductive film, a thickness Y of a region formed of the binder resin was 0.3 μm, and a height Z of a protruding portion of the metallic particle was 0.8 μm. Further, this transparent conductive film had a surface resistance value of 53.2 Ω/□. However, the contact resistance value thereof was more than 300Ω, and hence was not able to be measured. The transparent conductive film had a haze value of 3.3%, and the scratch resistance thereof was evaluated as o.

TABLE 1

| | | First | Second | | | Thickness Y of | | | | | |
|---|---|---|---|---|---|---|---|---|---|---|---|
| | | composition | composition | Primary | | transparent | Height Z of | Surface | Contact | | |
| | | for forming | for forming | particle | | conductive | protruding | resistance | resistance | | |
| | | conductive | conductive | diameter of | | layer | portion | value | value | Haze | Scratch |
| | Particle | layer | layer | particle | | (μm) | (μm) | (Ω/□) | (Ω/□) | (%) | resistance |
| Example A1 | Silver | Metal | Binder | 1.3 | μm | 0.3 | 0.9 | 50.3 | 1.2 | 2.9 | ∘ |
| | particle | nanowire + | | | | | | | | | |
| | | metallic | | | | | | | | | |
| | | particle | | | | | | | | | |
| Example A2 | Silver | Metal | Binder | 1.3 | μm | 1 | 0.4 | 51.2 | 3.7 | 3.0 | ∘ |
| | particle | nanowire + | | | | | | | | | |
| | | metallic | | | | | | | | | |
| | | particle | | | | | | | | | |
| Example A3 | Silver | Metal | Binder | 20 | nm | 0.3 | 1.3 | 49.8 | 0.4 | 2.5 | ∘ |
| | particle | nanowire + | | | | | | | | | |
| | | metallic | | | | | | | | | |
| | | particle | | | | | | | | | |
| Example A4 | Silver | Metal | Binder | 1.7 | μm | 0.3 | 1.5 | 49.1 | 2.8 | 2.0 | ∘ |
| | particle | nanowire + | | | | | | | | | |
| | | metallic | | | | | | | | | |
| | | particle | | | | | | | | | |
| Example A5 | Silver | Metal | Binder | 5.1 | μm | 0.3 | 4.8 | 53.0 | 11.3 | 1.8 | ∘ |
| | particle | nanowire + | | | | | | | | | |
| | | metallic | | | | | | | | | |
| | | particle | | | | | | | | | |
| Example A6 | Silver-coated | Metal | Binder | 1.1 | μm | 0.3 | 0.7 | 52.1 | 3.0 | 2.5 | ∘ |
| | copper | nanowire + | | | | | | | | | |
| | particle | metallic | | | | | | | | | |
| | | particle | | | | | | | | | |
| Example A7 | Silver | Metal | Binder + | 1.3 | μm | 0.3 | 1.1 | 53.2 | 1.5 | 2.8 | ∘ |
| | particle | nanowire | metallic | | | | | | | | |
| | | | particle | | | | | | | | |
| Example A8 | Silver | Metal | Binder + | 20 | nm | 0.3 | 0.7 | 50.9 | 0.8 | 2.6 | ∘ |
| | particle | nanowire | metallic | | | | | | | | |
| | | | particle | | | | | | | | |
| Example A9 | Silver | Metal | Binder + | 1.7 | μm | 0.3 | 1.6 | 52.3 | 2.4 | 3.0 | ∘ |
| | particle | nanowire | metallic | | | | | | | | |
| | | | particle | | | | | | | | |
| Example A10 | Silver | Metal | Binder + | 5.1 | μm | 0.3 | 4.9 | 54.2 | 8.4 | 2.0 | ∘ |
| | particle | nanowire | metallic | | | | | | | | |
| | | | particle | | | | | | | | |
| Example A11 | Silver-coated | Metal | Binder + | 1.1 | μm | 0.3 | 0.9 | 57.4 | 3.4 | 2.1 | ∘ |
| | copper | nanowire | metallic | | | | | | | | |
| | particle | | particle | | | | | | | | |
| Comparative | — | Metal | Binder | — | | 0.3 | — | 52.1 | Unmea- | 1.6 | ∘ |
| Example A1 | | nanowire | | | | | | | surable | | |
| Comparative | Antimony tin | Metal | Binder | 20 | nm | 0.3 | 0.8 | 53.2 | Unmea- | 3.3 | ∘ |
| Example A2 | oxide particle | nanowire | | | | | | | surable | | |

### Examples B1 to B3 and Reference Examples B1 and B2

Evaluation methods in Examples B1 to B3 and Reference Examples B1 and B2 are as described below. The thickness was measured as follows: a transparent conductive film was subjected to embedding treatment with an epoxy resin, and then a section was formed by cutting the resultant with an ultramicrotome, followed by the measurement of the thickness of the section with a scanning electron microscope “S-4800” manufactured by Hitachi High-Technologies Corporation.

### (1) Total Light Transmittance

A transparent conductive film was bonded to glass with a pressure-sensitive adhesive, and measurement was performed with a product available under the product name “HR-100” from Murakami Color Research Laboratory Co., Ltd. at 23° C.

### (2) Surface Resistance Value

Measurement was performed in the same manner as in Examples A1 to A11.

### (3) Contact Resistance Value

Measurement was performed in the same manner as in Examples A1 to A11.

### (4) Measurement of Average Particle Diameter and Average Ellipticity of Metallic Particle

Measurement was performed through use of an optical microscope “BX-51” manufactured by Olympus Corporation, a scanning electron microscope “S-4800” manufactured by Hitachi High-Technologies Corporation, and a field-emission transmission electron microscope “HF-2000” manufactured by Hitachi High-Technologies Corporation. An average particle diameter was defined as a median diameter (50% diameter; on a number basis) of particle diameters (long diameter) measured by observing 100 particles (metallic particles present as single particles and an aggregate) sampled randomly from a surface of a transparent conductive layer with the microscope. An average ellipticity was calculated by the expression “Average ellipticity (%)=(1−D2/D1)×100” based on a median diameter (50% diameter; on a number basis) D1 of a long diameter and a median diameter (50% diameter; on a number basis) D2 of a short diameter measured by observing 30 particles sampled randomly from a section of a transparent conductive layer with the microscope.

### (5) Measurement of Size of Metal Nanowire

Measurement was performed in the same manner as in Examples A1 to A11.

### Production Example B1<Production of Metal Nanowire>

A silver nanowire dispersion liquid a was prepared in the same manner as in Production Example A1.

### Production Example B2<Production of Reference Film>

### (Preparation of First Composition (Ref) for Forming Transparent Conductive Layer)

25 parts by weight of the silver nanowire dispersion liquid a was diluted with 75 parts by weight of pure water to prepare a first composition (Ref) for forming a transparent conductive layer having a solid content concentration of 0.05 wt %.

### (Preparation of Second Composition for Forming Transparent Conductive Layer)

3.6 parts by weight of pentaerythritol triacrylate (manufactured by Osaka Organic Chemical Industry Ltd., product name: “Viscoat#300”), 2.7 parts by weight of organosilicasol (manufactured by Nissan Chemical Industries. Ltd., product name: “MEK-AC-2140Z”, concentration: 40%), and 0.2 part by weight of a photopolymerization initiator (manufactured by BASF, product name: “IRGACURE 907”) were diluted with 93 parts by weight of cyclopentanone to provide a second composition for forming a transparent conductive layer having a solid content concentration of 5 wt %.

### (Production of Transparent Conductive Film)

The first composition (Ref) for forming a transparent conductive layer was applied onto a PET substrate (manufactured by Mitsubishi Plastics, Inc., product name: “T602”, thickness: 50 μm) through use of a wire bar No. 26 (manufactured by Mitsui Electric Co., Ltd.) and was dried.

In addition, the second composition (Ref) for forming a transparent conductive layer was applied onto the applied layer thus formed by spin coating (1,000 rpm, 5 seconds), and was dried at 90° C. for 1 minute. After that, the resultant was irradiated with UV light at 300 mJ/cm² to provide a transparent conductive film. In this transparent conductive film, the thickness of a region formed of the binder resin (for convenience, shown as “Thickness of transparent conductive layer” in Table 1) was 0.3 μm. This transparent conductive film had a total light transmittance of 89.8%.

### Example B1

### (Preparation of First Composition (NP-1) for Forming Transparent Conductive Layer)

25 parts by weight of the silver nanowire dispersion liquid a and 2 parts by weight of a water dispersion liquid A of 1 wt % silver particles (containing silver particles available under the product name “Silvest AgS-050” from Tokuriki Chemical Research Co., Ltd.; average primary particle diameter of the silver particles: 0.5 μm, average ellipticity of the silver particles: 10.3%) were diluted with 75 parts by weight of pure water to prepare a first composition (NP-1) for forming a transparent conductive layer having a solid content concentration of 0.07 wt %.

### (Production of Transparent Conductive Film)

A transparent conductive film was obtained in the same manner as in Production Example B2 except that the first composition (NP-1) for forming a transparent conductive layer was used as the first composition for forming a transparent conductive layer. In this transparent conductive film, the thickness of a region formed of a binder resin was 0.3 μm. Further, part of metallic particles protruded from the region formed of the binder resin, and the height of the protruding portion was 0.1 μm. Further, the obtained transparent conductive film had a surface resistance value of 52.0Ω/□, a contact resistance value of 0.6Ω, and a total light transmittance of 89.3%, and a difference ΔT between the total light transmittance of the obtained transparent conductive film and the total light transmittance of a reference film was 0.5%.

### Example B2

### (Preparation of First Composition (NP-2) for Forming Transparent Conductive Layer)

A first composition (NP-2) for forming a transparent conductive layer was prepared in the same manner as in Example B1 except that a water dispersion liquid B of 1 wt % silver particles (containing silver particles available under the product name “SPN05S” from Mitsui Mining & Smelting Co., Ltd.; average primary particle diameter of the silver particles: 1.3 μm, average ellipticity of the silver particles: 4.0%) was used instead of the water dispersion liquid A of 1 wt % silver particles.

### (Production of Transparent Conductive Film)

A transparent conductive film was obtained in the same manner as in Example B1 except that the first composition (NP-2) for forming a transparent conductive layer was used as the first composition for forming a transparent conductive layer. In this transparent conductive film, the thickness of a region formed of a binder resin was 0.3 μm. Further, part of metallic particles protruded from the region formed of the binder resin, and the height of the protruding portion was 0.9 μm. Further, the obtained transparent conductive film had a surface resistance value of 53.0 Ω/□, a contact resistance value of 2.7Ω, and a total light transmittance of 89.1%, and a difference ΔT between the total light transmittance of the obtained transparent conductive film and the total light transmittance of a reference film was 0.7%.

### Example B3

### (Preparation of First Composition (NP-3) for Forming Transparent Conductive Layer)

A first composition (NP-3) for forming a transparent conductive layer was prepared in the same manner as in Example B1 except that a water dispersion liquid C of 1 wt % silver particles (containing silver particles available under the product name “SPN08S” from Mitsui Mining & Smelting Co., Ltd.; average primary particle diameter of the silver particles: 1.7 μm, average ellipticity of the silver particles: 2.7%) was used instead of the water dispersion liquid A of 1 wt % silver particles.

### (Production of Transparent Conductive Film)

A transparent conductive film was obtained in the same manner as in Example B1 except that the first composition (NP-3) for forming a transparent conductive layer was used as the first composition for forming a transparent conductive layer. In this transparent conductive film, the thickness of a region formed of a binder resin was 0.3 μm. Further, part of metallic particles protruded from the region formed of the binder resin, and the height of the protruding portion was 1.3 μm. Further, the obtained transparent conductive film had a surface resistance value of 49.1 Ω/□, a contact resistance value of 2.8Ω, and a total light transmittance of 89.2%, and a difference ΔT between the total light transmittance of the obtained transparent conductive film and the total light transmittance of a reference film was 0.6%.

### Reference Example B1

### (Preparation of First Composition (NP-4) for Forming Transparent Conductive Layer)

A first composition (NP-4) for forming a transparent conductive layer was prepared in the same manner as in Example B1 except that a water dispersion liquid D of 1 wt % silver particles (containing silver particles available under the product name “Q03R flake” from Mitsui Mining & Smelting Co., Ltd.; average primary particle diameter of the silver particles: 1.1 μm, average ellipticity of the silver particles: 90.1%) was used instead of the water dispersion liquid A of 1 wt % silver particles.

### (Production of Transparent Conductive Film)

A transparent conductive film was obtained in the same manner as in Example B1 except that the first composition (NP-4) for forming a transparent conductive layer was used as the first composition for forming a transparent conductive layer. In this transparent conductive film, the thickness of a region formed of a binder resin was 0.3 μm. Further, part of metallic particles protruded from the region formed of the binder resin, and the height of the protruding portion was 0.7 μm. Further, the obtained transparent conductive film had a surface resistance value of 51.1 Ω/□, a contact resistance value of 1.2Ω, and a total light transmittance of 88.1%, and a difference ΔT between the total light transmittance of the obtained transparent conductive film and the total light transmittance of a reference film was 1.7%.

### Reference Example B2

### (Preparation of First Composition (NP-5) for Forming Transparent Conductive Layer)

A first composition (NP-5) for forming a transparent conductive layer was prepared in the same manner as in Example B1 except that a water dispersion liquid E of 1 wt % silver particles (containing silver particles available under the product name “Silvest TCG-1” from Tokuriki Chemical Research Co., Ltd.; average primary particle diameter of the silver particles: 3.5 μm, average ellipticity of the silver particles: 78.7%) was used instead of the water dispersion liquid A of 1 wt % silver particles.

### (Production of Transparent Conductive Film)

A transparent conductive film was obtained in the same manner as in Example B1 except that the first composition (NP-5) for forming a transparent conductive layer was used as the first composition for forming a transparent conductive layer. In this transparent conductive film, the thickness of a region formed of a binder resin was 0.3 μm. Further, part of metallic particles protruded from the region formed of the binder resin, and the height of the protruding portion was 2.6 μm. Further, the obtained transparent conductive film had a surface resistance value of 51.9Ω/□, a contact resistance value of 1.5Ω, and a total light transmittance of 87.9%, and a difference ΔT between the total light transmittance of the obtained transparent conductive film and the total light transmittance of a reference film was 1.9%.

TABLE 2

| | | | Thickness | | | | |
|---|---|---|---|---|---|---|---|
| | | | of | | | | |
| | Metallic particle | | transparent | Surface | Contact | | |
| | Particle | | conductive | resistance | resistance | Total light | |
| | diameter | Ellipticity | layer | value | value | transmittance | ΔT |
| | (μm) | (%) | (μm) | (Ω/□) | (Ω) | (%) | (%) |
| Production | — | — | 0.3 | 52.2 | — | 89.8 | — |
| Example B2 | | | | | | | |
| (Reference | | | | | | | |
| film) | | | | | | | |
| Example B1 | 0.5 | 10.3 | 0.3 | 52.0 | 0.6 | 89.3 | 0.5 |
| Example B2 | 1.3 | 4.0 | 0.3 | 53.0 | 2.7 | 89.1 | 0.7 |
| Example B3 | 1.7 | 2.7 | 0.3 | 49.1 | 2.8 | 89.2 | 0.6 |
| Reference | 1.1 | 90.1 | 0.3 | 51.1 | 1.2 | 88.1 | 1.7 |
| Example B1 | | | | | | | |
| Reference | 3.5 | 78.7 | 0.3 | 51.9 | 1.5 | 87.9 | 1.9 |
| Example B2 | | | | | | | |

### INDUSTRIAL APPLICABILITY

The transparent conductive film of the present invention can be used in an electronic device, such as a display element.

### REFERENCE SIGNS LIST

10 transparent substrate
20 transparent conductive layer
21 binder resin
22 metal nanowire
23 metallic particle
100 transparent conductive film

1. A transparent conductive film, comprising:
a transparent substrate; and
a transparent conductive layer arranged on one side or both sides of the transparent substrate,
wherein:
the transparent conductive layer contains a binder resin, metal nanowires, and metallic particles; and
part of the metallic particles protrude from a region formed of the binder resin.

2. The transparent conductive film according to claim 1, wherein an average particle diameter X of the metallic particles and a thickness Y of the region formed of the binder resin satisfy a relationship of Y≦X≦20Y.

3. The transparent conductive film according to claim 1, wherein the metallic particles have an average primary particle diameter of from 5 nm to 100 μm.

4. The transparent conductive film according to claim 1, wherein a content ratio of the metallic particles is from 0.1 part by weight to 20 parts by weight with respect to 100 parts by weight of the binder resin.

5. The transparent conductive film according to claim 1, wherein the metallic particles have an average ellipticity of 40% or less.

6. The transparent conductive film according to claim 1, wherein the metallic particles comprise silver particles.

7. The transparent conductive film according to claim 1, wherein the metallic particles comprise silver-coated copper particles.

8. An optical laminate, comprising:
the transparent conductive film of claim 1; and
a polarizing plate.
